(19) United States
(12) Patent Application Publication
(10) Pub. No.: US 2014/0074495 A1
(43) Pub. Date: Mar. 13, 2014

(54) AMBULATORY SURGERY CENTERS

(71) Applicant: Arne Brock-Utne, Lafayette, CA (US)

(72) Inventor: Arne Brock-Utne, Lafayette, CA (US)

(21) Appl. No.: 13/827,888

(22) Filed: Mar. 14, 2013

Related U.S. Application Data
(60) Provisional application No. 61/700,810, filed on Sep. 13, 2012.
(60) Provisional application No. 61/725,896, filed on Nov. 13, 2012.

(51) Int. Cl. G06Q 10/06; G06Q 50/22

(52) U.S. Cl. CPC G06Q 10/063; G06Q 50/22
USPC 705/2

(57) ABSTRACT

Provided are mobile and electronics powered healthcare facilities and systems for providing improved healthcare services to patients. In particular, a healthcare facility is provided comprising a waiting area, a pre-operative area, an operating area, a recovery area and a central processing area, each area comprising an electronic screen for displaying information about patients, healthcare professionals, and related facilities and equipments

### CROSS-REFERENCE TO RELATED APPLICATIONS

This application claims the benefit under 35 U.S.C. §119(e) to U.S. Provisional Application Ser. Nos. 61/700,810, filed Sep. 13, 2012, and 61/725,896, filed Nov. 13, 2012, the contents of each of which are incorporated by reference in their entireties into the present disclosure.

### FIELD OF THE DISCLOSURE

The present invention generally relates to the use of electronic and mobile devices to improve quality and efficiencies in healthcare facilities, in particular ambulatory surgery centers.

### BACKGROUND

Coordination and management of patient care in healthcare facilities are still carried our manually these day even when electronic and mobile devices are widely used in the society. For instance, paper and fax are still the norm in communication between patients, healthcare professionals, and healthcare facilities. Such methods are slow, inaccurate, and prone to human errors, cause compliance concerns and lead to higher costs.

There is a need to improve quality and efficiencies in healthcare facilities, in particular ambulatory surgery centers. This invention addresses this need and provides related advantages as well.

### SUMMARY

One embodiment of the present disclosure provides a healthcare service or facility comprising a waiting area, a pre-operative area, an operating area, a recovery area and a central processing area, wherein: the waiting area comprises a waiting area screen configured to display a plurality of patients at the facility or expected to arrive at the facility, and for each patient, in what area the patient is located and/or what procedure the patient is taking; the pre-operative area comprises a pre-operative area screen configured to display, for each of the patients, one or more of: arrival status, assigned pre-operative bay, procedure to take, assigned surgeon, assigned anesthesiologist, assigned pre-operative nurse, assigned operating area nurse, and/or assigned operating area; the operating area comprises an operating area screen configured to display, for a patient of the plurality that is currently in the operating area, one or more of: the procedure to take, allergies, equipments needed, administration of antibiotics, and/or special requests; the recovery area comprises a recovery area screen configured to display a list of patients that are finishing operation, and an assigned recovery bay therefor; and the central processing area comprises a central processing area screen configured to display equipments and/or services needed for any patient and/or in any area in the facility.

In one embodiment, at least one of the screens is further configured to display, for a patient of the plurality, one or more risk factor associated with the patient and a recommended action in response to the risk factor.

Another embodiment provides a computer system comprising a processor, memory and program code which, when executed, configures the system to: take input from a healthcare facility personnel about a patient receiving healthcare service, wherein the input comprises biometric and/or medical conditions of the patient, and one or more expected surgical operation for the patient; send an electronic pre-operative alert to the patient prior to the operation; send an electronic post-operation alert to the patient following the operation; send an electronic physician alert to a physician assigned to the patient for the operation prior to or during the operation; and send an electronic nurse alert to a nurse assigned to the patient for the operation prior to, during or following the operation.

Also provided is a computer system comprising a processor, memory and program code which, when executed, configures the system to: take pre-operative information from a patient expected to take an surgical operation, which pre-operative information comprises scores from measuring three or more factors of: consciousness, activity, hemodynamics, response, oxygen saturation, pain, and/or nausea from the patient; take post-operation information from the patient after the patient has completed the operation, which post-operation information comprises scores from measuring the three or more factors from the patient; and display an improvement score based on the pre-operative information and the post-operation information for the patient for each of the factors.

Yet another embodiment provides a computer system comprising a processor, memory and program code which, when executed, configures the system to calculate the duration of a surgical operation for a patient performed by a surgeon assisted with an anesthesiologist, wherein the calculation takes as input (a) information about the patient affecting duration of the operation and (b) a historic database, wherein the database comprises durations of a plurality of surgical operations performed by the surgeons and/or assisted by the anesthesiologist for a plurality of patients and, for each patient of the plurality, information about the patient.

### BRIEF DESCRIPTION OF THE DRAWINGS

Provided embodiments are illustrated by way of example, and not limitation, in the figures of the accompanying drawings in which:

FIG. 1 illustrates information that can be displayed on a screen in any area of a healthcare facility;

FIG. 2 illustrates a screen placed in a waiting area of a healthcare facility;

FIG. 3 illustrates a screen placed in a pre-operative area of a healthcare facility;

FIG. 4 illustrates a screen placed in an operating area of a healthcare facility;

FIG. 5 is another screen shot from a screen placed in a waiting area of a healthcare facility;

FIG. 6 illustrates a screen placed in a hall way of a healthcare facility;

FIG. 7 illustrates a screen placed in a recovery area of a healthcare facility;

FIG. 8 illustrates a screen placed in a break area of a healthcare facility;

FIG. 9 illustrates a screen placed in a sterile area of a healthcare facility;

FIG. 10 shows a table listing improvement scores for a patient receiving a medical procedure, as compared to patients in a related group and in the country;

FIG. 11 illustrates an interface for obtaining a patient input for the patient's height and weight, which can be used to determine the body mass index (BMI) for the patient;

FIG. 12 illustrates an interface that can be configured to take input from a patient or a staff member useful for assessing the fall risk of the patient;

FIG. 13 shows a screen that displays the projected high fall risk for a patient;

FIG. 14 shows a pre-operative checklist in which checking of certain items, e.g., fall risk policy, is optional;

FIG. 15 shows a similar checklist as FIG. 14 but with more mandatory checklist items;

FIG. 16 shows a pre-operative checklist in which not every mandatory items have been checked off and thus the “Ready for OR” button is not available;

FIG. 17 shows a similar checklist as FIG. 16 but all mandatory items have been cleared; hence the patient is ready for the operation room (OR);

FIG. 18 shows a conventional operation room schedule; and

FIG. 19 shows an operation room schedule of the present disclosure.

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION

As used herein, certain terms have the following defined meanings. Terms that are not defined have their art recognized meanings.

As used in the specification and claims, the singular form “a”, “an” and “the” include plural references unless the context clearly dictates otherwise.

As used herein, the term “comprising” is intended to mean that the components, systems and methods include the recited elements, but not excluding others. “Consisting essentially of” when used to define components, systems and methods, shall mean excluding other elements that would materially affect the basic and novel characteristics of the disclosure. “Consisting of” shall mean excluding any element, step, or component not specified in the claim. Embodiments defined by each of these transition terms are within the scope of this disclosure.

### Details of the Disclosure

### Healthcare Service Facilities

One embodiment of the present disclosure provides a healthcare service system and/or facility, such as an ambulatory surgery center. In some embodiments, the healthcare system service system and/or facility comprises a waiting area, a pre-operative area, an operating area, a recovery area and a central processing area.

In one aspect, the waiting area comprises a waiting area display such as a screen configured to display a plurality of patients at the facility or expected to arrive at the facility, and for each patient, in what area the patient is to be located upon arrival or located and/or what procedure the patient is or will be taking.

In one aspect, the pre-operative area comprises a pre-operative area screen configured to display, for each of the patients, one or more of: arrival status, assigned pre-operative bay, procedure to take, assigned surgeon, assigned anesthesiologist, assigned pre-operative nurse, assigned operating area nurse, and/or assigned operating area.

In one aspect, the operating area comprises an operating area screen configured to display, for a patient of the plurality that is currently in the operating area, one or more of: the procedure to take, allergies, equipments needed, administration of antibiotics, and/or special requests.

In one aspect, the recovery area comprises a recovery area screen configured to display a list of patients that are finishing operation, and an assigned recovery bay therefor.

In one aspect, the central processing area comprises a central processing area screen configured to display equipments and/or services needed for any patient and/or in any area in the facility.

In one aspect, the facility further comprises a break area comprising a break area screen configured to display to facility staff on break the status and/or location of the patients.

In one aspect, the facility further comprises a hallway comprising a hallway screen configured to display a list of operating areas in the facility and status of patients assigned to each operating area.

In one aspect, the pre-operative area screen is further configured to display for each patient whether the patient has seen the assigned surgeon, the assigned anesthesiologist, the assigned pre-operative nurse and/or the operating area nurse, and/or whether the assigned operating area is ready.

In one aspect, the pre-operating area screen is further configured to indicate that the patient is ready to receive operation at the assigned operation room when the patient has seen the assigned surgeon, the assigned anesthesiologist, the assigned pre-operative nurse and the operating area nurse, and the assigned operating area is ready.

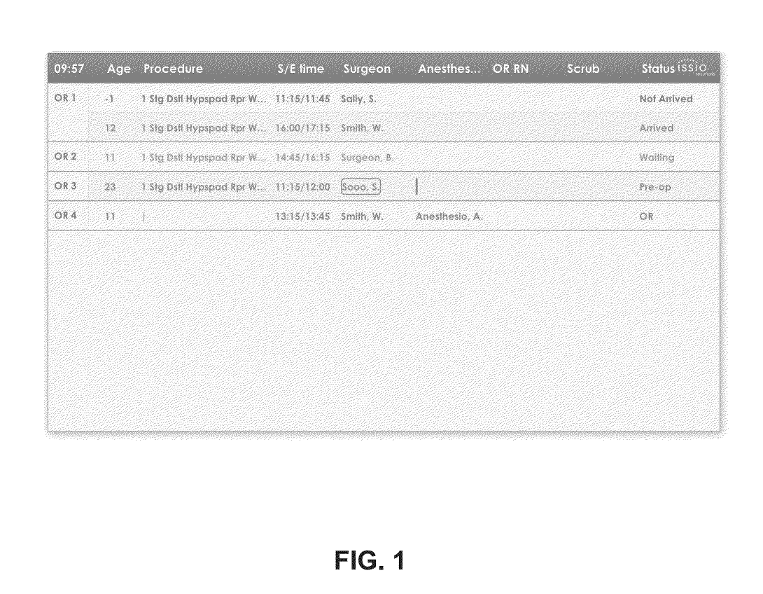

Various embodiments of the healthcare service facility are illustrated in the accompanying figures. With reference to FIG. 1, certain patient information can be displayed in any screen in the facility. The first row illustrated in FIG. 1 is headings indicating patient procedure information. Row 2, which can be shown in a color (e.g., red) indicates that a patient has not arrived at the facility. Row 3, in pink for instance, indicates that a patient has arrived at the facility but has not completed the patient arrival form. Still in a different color, row 4 shows a patient that has arrived, completed the patient arrival form, and is waiting in the waiting area (or waiting room). Further, row 5 shows a patient that is present in the pre-operative (Pre-OP) area. Row 6, moreover, shows a patient that is present in the operating area (or operating room, OR). In another example (not shown), a patient has completed surgery and is present in the recovery area (PACU).

It is contemplated that the screen does not log out automatically and automatically refreshes periodically, e.g., every 60 seconds or so to update patient information.

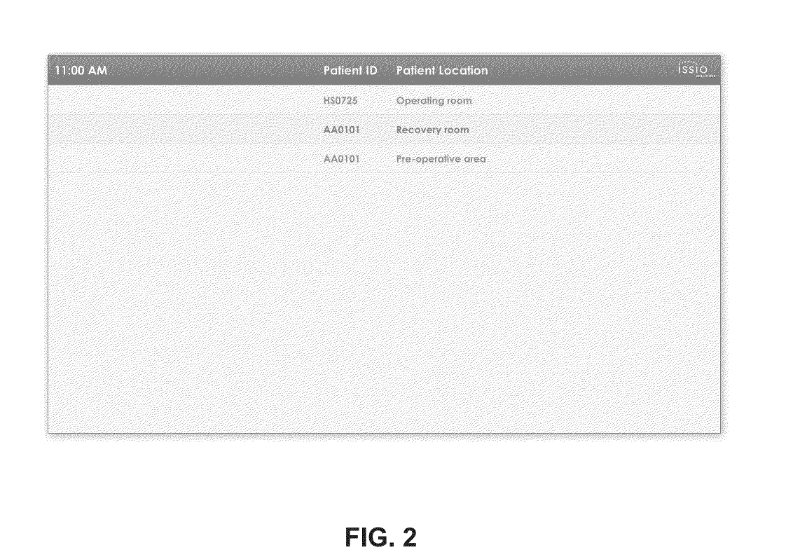

FIG. 2 illustrates a screen placed in a waiting area of a healthcare service or facility. This screen shows where the patient is in the process, e.g., it allows family members where their loved ones are in the process: pre-op, OR, or PACU. The screen also lets the front desk staff know where the patients are.

Like FIG. 1, the first row on the screen shows headings that include time, patient identification (ID), and patient location. Row 2 shows a patient, represented by a patient ID, is present in the operating area. The patient shown in row 3, similarly, is present in the recovery area. Further, row 3 shows a patient in the Pre-OP area. This screen is used to display status about patients to patients or their friends or family in the waiting area, so that they can be well informed about the status of the patients. In one aspect, this screen does not display patients who have not yet arrived or are waiting to be taken back to the Pre-OP area.

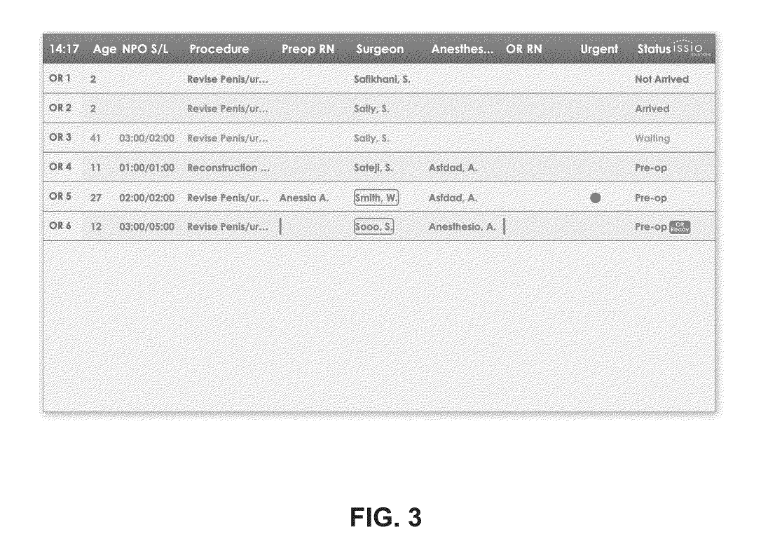

An illustrative screen of the Pre-OP area is shown in FIG. 3. This screen will display information specific for health care providers, e.g., nurses and physicians, in the pre-op area. For example patient arrival status—if the patient has not arrived, has arrived and is waiting. Also what pre-op bay they will be in, what procedure they are having, who their surgeon, anesthesiologist, pre-op and OR nurses are. The screen will also display if the OR is ready. Once these 4 users have seen the patient, their name will be circled on the Pre-op screen—so everyone at the ASC knows this has happened. Once both nurses, anesthesiologist and surgeon have seen the patient, and the OR is ready, the patient's name will start flashing on the screen, indicating that they are ready to move to the OR.

Columns on this screen, as indicated by the headings in row 1, include age, pre-operative fasting guideline (NPO) solids/liquids, procedure to take, pre-operative nurse, surgeon, anesthesiologist, operating room nurse, urgency and status. Row 2 shows a patient that has not arrived at the facility and row 2 shows a patient that has. Row 4 lists a patient that has arrived, completed the patient arrival form, and is waiting in the waiting area. The “waiting” status will flash as the patient is waiting to be relocated to the Pre-OP area.

Also in FIG. 3, patients in rows 5-7 are all present in the Pre-OP area. The patient in row 6 has been assigned a surgeon, whose name is circled indicating that the surgeon has approved the patient for surgery. In row 7, the assigned surgeon has approved patient for surgery and the operating room (OR) is ready to accept the patient.

Additionally, the dark gray dot in row 6 indicates to the nurses that some aspects of the patient's Pre-OP checklist needs to be addressed with the surgeon and/or anesthesiologist prior to moving the patient to the OR.

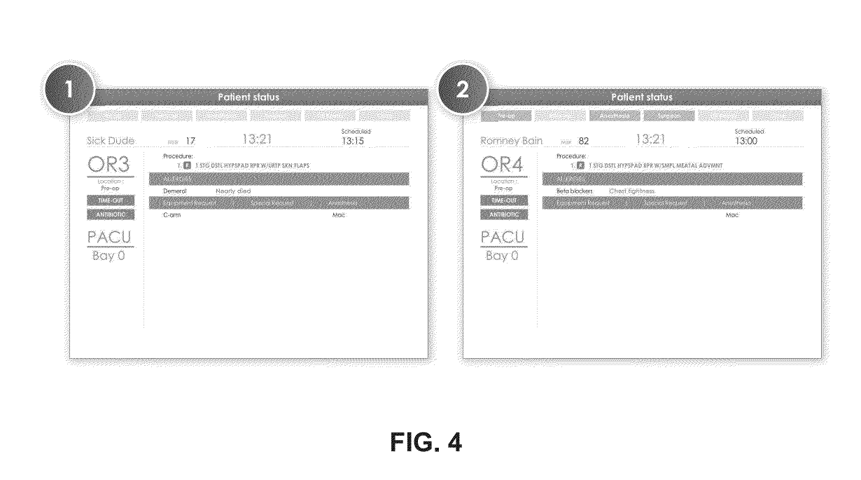

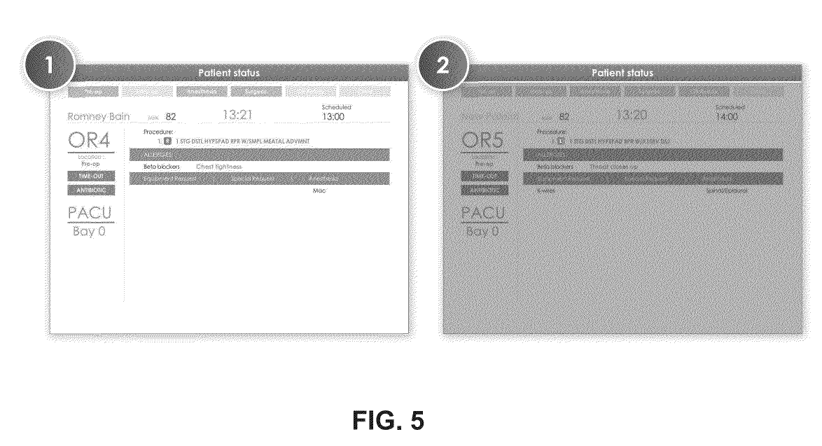

FIGS. 4 and 5 illustrate screenshots from a screen placed in an operating area (or operating room, OR). At least one OR status displays in each OR. Each status screen displays one patient at a time. If there is not a patient present in the OR, the next patient in Pre-OP scheduled for the same OR will be displayed. There are Pre-op, Intra-op, Anesthesiologist, Surgeon, OR Ready, and Close indicators across the top of each screen. These indicators are displayed in grey when not ready (FIG. 4, left panel) and turn green when each user's Pre-op checklist is complete (FIG. 4, right panel).

This can be a mobile device, a flat screen TV in the OR that displays information specific to the patient currently in that OR, or about to enter the OR. This screen will display patient name, scheduled procedure, allergies, equipment needed for the surgery, special requests, surgeon preferences, patient images. The screen will flash if antibiotics have not been given, or the surgical time-out has not been completed. This ensures that safety checks happen in a timely manner.

Time is displayed in an appropriate format for the facility, e.g., 24-hour format and located at the top-center of the screen. On the left column of the screen (top to bottom), the patient's name is displayed with the OR number, the patient's location, time-out, antibiotic and the planned bay number when the patient moves to the recovery area. The procedure, allergies, requested equipment, special request(s), and anesthesia are all displayed in the center of the screen.

In FIG. 5, the left panel list two patients present in the Pre-OP area or the OR. The right panel, with the entire screen colored red (shown as gray), indicates that antibiotics have not been given and the surgical time-out has not been completed. The patient name, when flashing, shows that the patient arrival time has not been recorded.

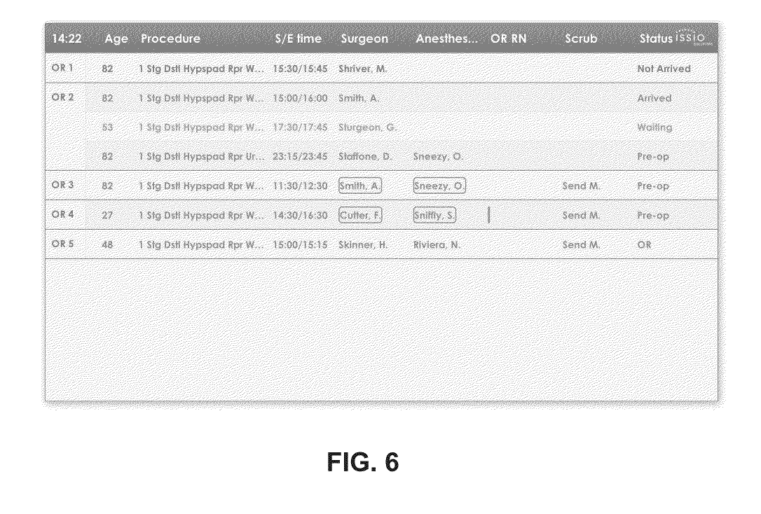

FIG. 6 illustrates a screen placed in a hall way of a healthcare facility. Row 4, for instance, shows a patient that has arrived, completed the patient arrival form, but is not present in the Pre-OP area. In row 5, the patient is present in the Pre-OP area. The following two rows show that the patients are in the Pre-OP area and are ready for the OR. In the last row, the patient is present in the OR. In one aspect, the hall way screen does not display patients who have not arrived or are present in the recovery area. This screen will show each OR in the facility and where the patients for those Ors are located (not arrived, arrived, waiting, Pre-OP, OR).

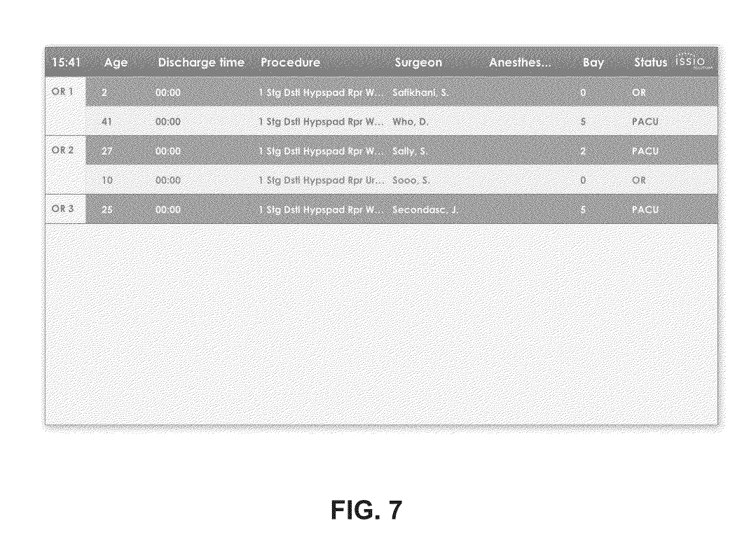

FIG. 7 illustrates a screen placed in a recovery area of a healthcare facility. This screen is in the recovery room or PACU. This screen can show where patients are from OR to PACU to Discharged. When the surgery is closing in the OR, the OR RN will push a button on their web enabled device that will start that patient's name flashing in the PACU—this will alert the PACU RNs that the patient is coming out of the OR shortly. The PACU RN will assign the patient a Bay in the PACU which will display on the OR screen so the OR staff know where to take the patient in PACU. In one aspect, this screen only displays patients present in the OR or the recovery area.

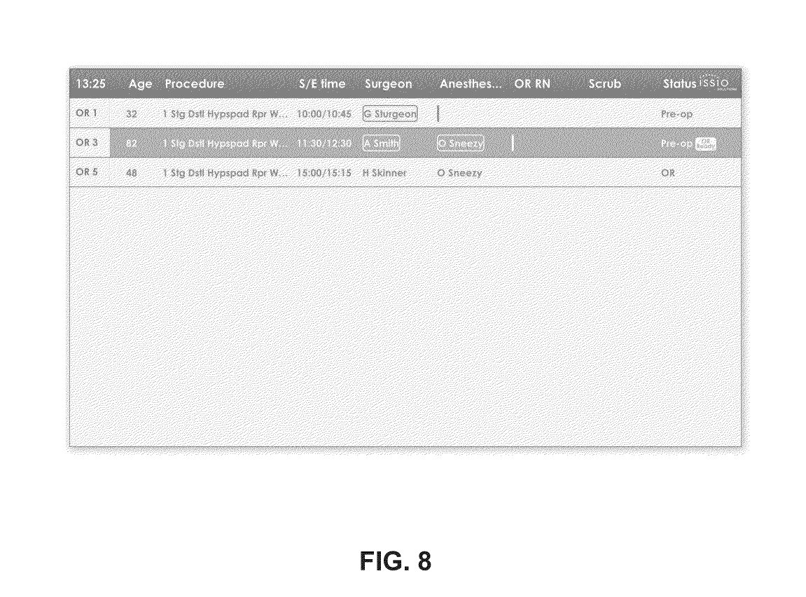

FIG. 8 illustrates a screen placed in a break area of a healthcare facility. A screen similar to the pre-op screen this screen will give information to staff in the break room—letting everyone know when the patient is ready to go from the Pre-op to the OR, and when the patient is in the OR or the PACU. In this screen, the first listed patient is present in the Pre-OP area, and a staff member (e.g., surgeon) has approved the patient for surgery. The second patient is also present in the Pre-OP area. The required staff members (Pre-OP nurse, intra-OP nurse, anesthesiologist, and surgeon) have all approved the patient for surgery and the OR-ready button has been selected. When this patient is present in the OR, the row will only flash if the patient's OR arrival time has not yet been populated. The last patient is present in the OR.

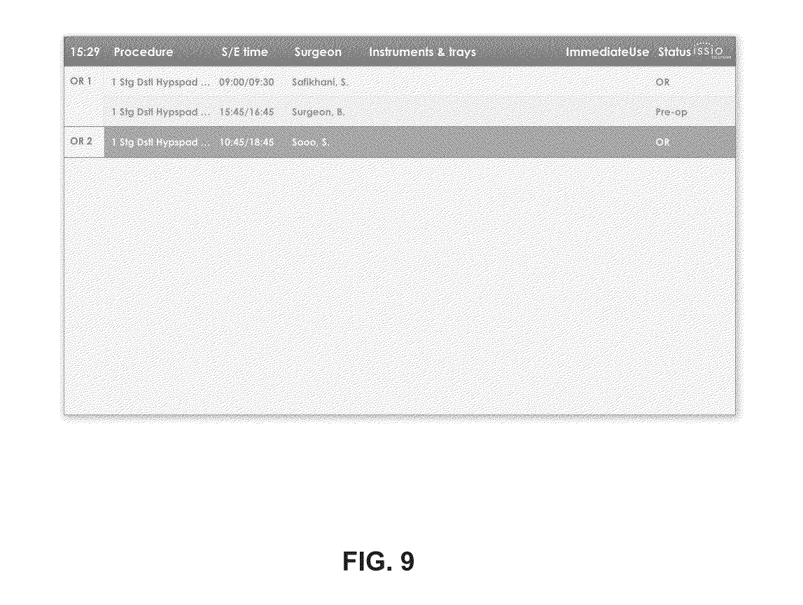

FIG. 9 illustrates a screen placed in a sterile area of a healthcare facility. The last row shows that the patient's procedure is closing, in which the dot indicates that the OR needs an instrument tray rapidly turned over for the next procedure in the same OR.

In some embodiments, a screen is placed at the central processing department. This screen can display to staff (CPD techs) who are getting equipment ready for surgery in the ORs. They will be able to see when a patient is coming out of the OR, thus knowing that they need to prepare equipment for the next procedure. The screen will also display the specific instruments and equipment that the surgeon has requested. If there is an “immediate use” item (one that is being used for a procedure and needs to be cleaned and reused right away) then the OR RN can click a button on their web-enabled device. This will cause an indication to appear on the screen in the CPD.

In some embodiments, the screen in each of the areas can be electronic display fixed in the area, and alternatively be portable so long as the screen is configured to display information designated for the area. Portable screens are readily available, such as screens on mobile devices (e.g., iPod®, iPhone®, Android® and Microsoft Phone® devices).

### Automatic Alerts

The screens and the computer systems in the facility can be configured to provide automatic alerts to staff for taking certain actions based on the patient's conditions. In some embodiments, at least one of the screens is further configured to display, for a patient of the plurality, one or more risk factor associated with the patient and a recommended action in response to the risk factor. In one aspect, the screen is further configured to display whether the recommended action has been taken.

Non-limiting examples of the risk factor include overweight, hypertension, abnormal blood glucose level, pain, allergy, nausea, infection, cardiac condition, pulmonary condition, and combinations thereof.

In some embodiments, the system can also create a “physician order set” for patients with specific medical conditions, based on a physician's preference and recommendations. Such an order set is saved in the system, and is associated with the physician. Therefore, when a patient is assigned to the physician, the system will check information about the patient against the order set and alert the facility that certain actions need to be taken, based on such recorded preference and recommendations in the order set.

For instance, an anesthesiologist may have a warming blanket in pre-op ordered for any patients with a BMI (body mass index) less than 24. When a patient with a BMI<24 is admitted for that anesthesiologist, the order for a warming blanket for this patient will be displayed to the pre-op RN

The system in the facility can also be configured to receive information about these risk factors. It is believed that the collection of such information and the automatic alert generated from such information can help the facility improve healthcare quality and reduce risk, which ultimately leads to reduced cost and liability.

### Operating Room Scheduling

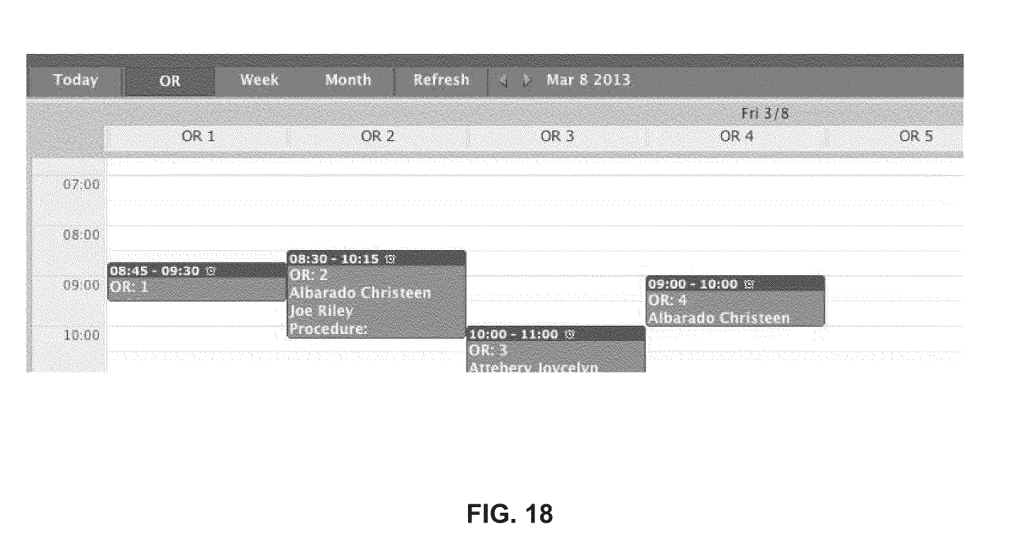

The present disclosure, in some embodiments, provides an improved operating room (OR) scheduling system and interface. FIG. 18, for instance, shows a conventional OR scheduling program and its interface, in which the schedule is listed for each individual OR. Further, as it is normally difficult to predict the duration of a procedure, the completion time of a procedure is frequently inaccurate.

There are a number of types of employees in the OR environment, however, that are responsible for what is going on in all the ORs, not just one (like an OR registered nurse, an anesthesiologist or a surgeon). Such “all OR” employees include orderlies (clean the rooms), CPD techs (clean and prepare the sterile equipment), charge nurses, recovery room nurses, without limitation.

For these types of employees, the conventional scheduling system and interface are difficult for them to use. This is because, at least in part, the listing by OR is difficult for the employees to synthesize the information to determine when he or she needs to go to a particular OR or to take a break. This is particularly true since the predicted completion time (time to complete the procedure and exit the OR) is often incorrect and typically not updated.

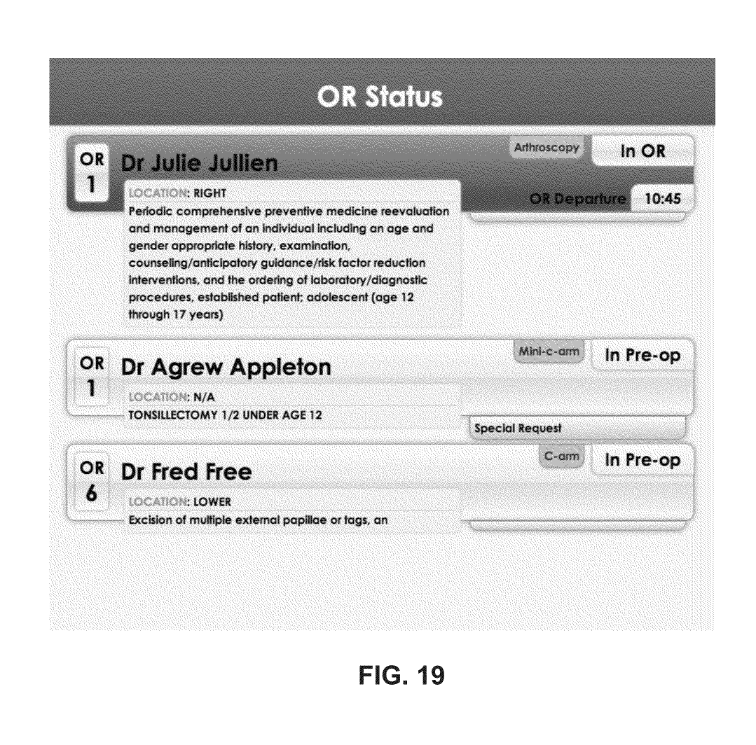

In accordance with one embodiment of the present disclosure, the system is configured to present an OR scheduling interface to be displayed on one or more of the screens as descried herein. As illustrated in FIG. 19, the OR scheduling interface places schedules for all ORs in a medical facility together in a single column.

Further, in some embodiments, the schedule of each procedure is required to indicate a completion time, at which time the patient and related medical professionals leave the OR. The starting time when a procedure starts to occupy an OR, in some embodiments, is optional and is often not indicated on the interface. Further, the system prompts employees in the OR during a procedure to update the completion time when appropriate. Therefore, the present system, in some embodiments, presents an OR scheduling system with accurate completion time for procedures in all ORs in an aggregated manner.

Such a system and interface, therefore, present unique advantages over the existing technologies. In one aspect, an employee no longer has to a guess by looking at a paper or electronic schedule listed by OR. Then, the employees can plan for their day better. For instance, they can take breaks at slower times—that is, when no rooms are predicted to come out for a couple of hours.

### Pre-Operative Checklist

Alerts and reminders can also be generated from information provided by the patients through, for instance, an interactive interface on a screen that takes input from the patients. Such interactive interface can also be used to receive other useful information which, in one aspect, can be used to confirm the patients and their anticipated procedures.

In one embodiment, the facility, device, service of method of the present disclosure further includes a screen configured to take input from a patient. In one aspect, the screen provides an interactive interface for taking input from the patient. The interface can be configured to perform one or more of the following activities: (1) receiving or confirming the contact information (e.g., phone number) of the patient, (2) receiving or confirming the date of birth and/or address of the patient, (3) receiving or confirming the procedure the patient anticipates to receive, and/or (4) receiving or confirming the surgeon the patient anticipates to see.

It is noted that, in actual medical practice, incorrectly scheduled procedures are common events. Such an interface and step, therefore, ensures that such mistakes are avoided. In some aspects, the interface presents one or more dummy answers, that are procedures or surgeons that do not exist. The inclusion of such dummy answer, therefore, facilitates the detection of errors.

Based on input from these interactions, the patient can be verified to be the correct patient taking the schedule procedure, or otherwise. If the patient is verified, the patient will be checked in by a staff member. Otherwise, the staff may advise the patient about the error and discuss with the patient about future scheduling, for instance, accordingly.

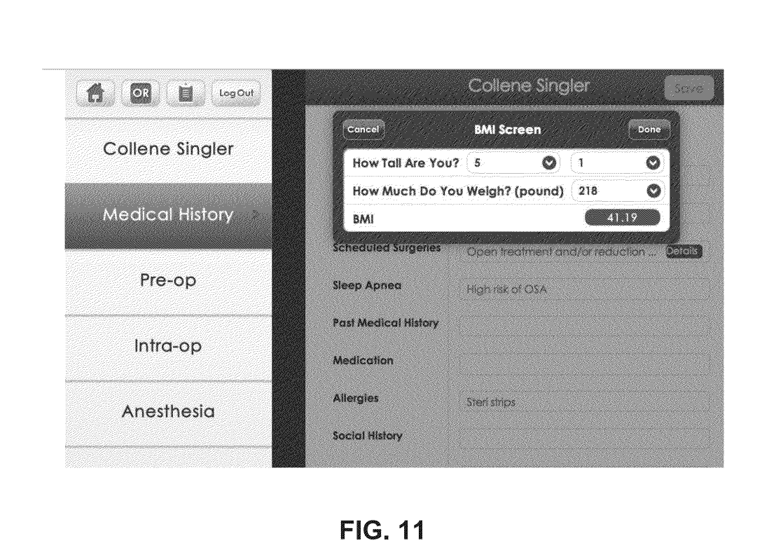

In another embodiment, the interface is configured to take input from a patient or a staff member regarding biometrics or medical history of the patient. For instance, in one aspect, as illustrated in FIG. 11, the interface asks the patient for the patient's height and weight, which can then be used to determine the body mass index (BMI) for the patient.

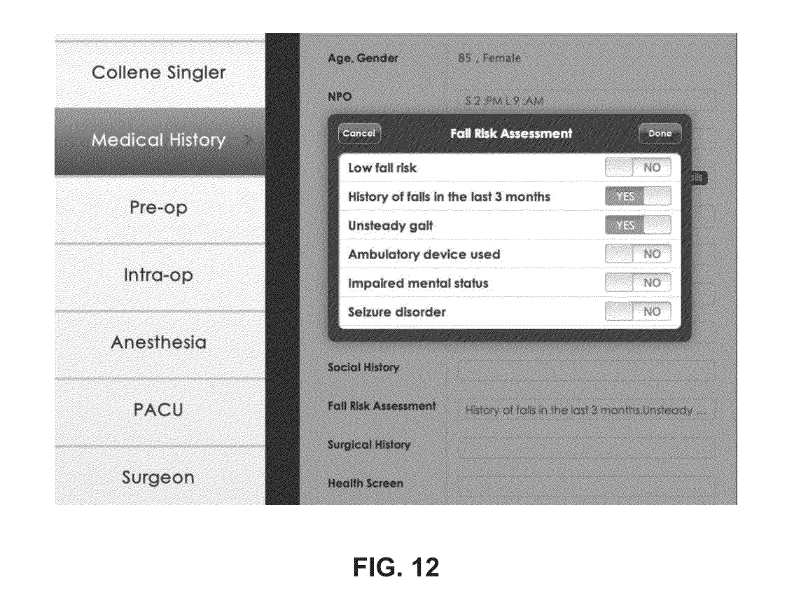

Likewise, as shown in FIG. 12, the interface can be configured to take input from a patient or a staff member that can be used to assess the fall risk of the patient. Questions used to receive such input can include, without limitation, (a) history of falls in the last three months, (b) unsteady gait, (c) ambulatory device used, (d) impaired mental status, or (e) seizure disorder. Based on the input, the system provides algorithm to assess the fall risk of the patient.

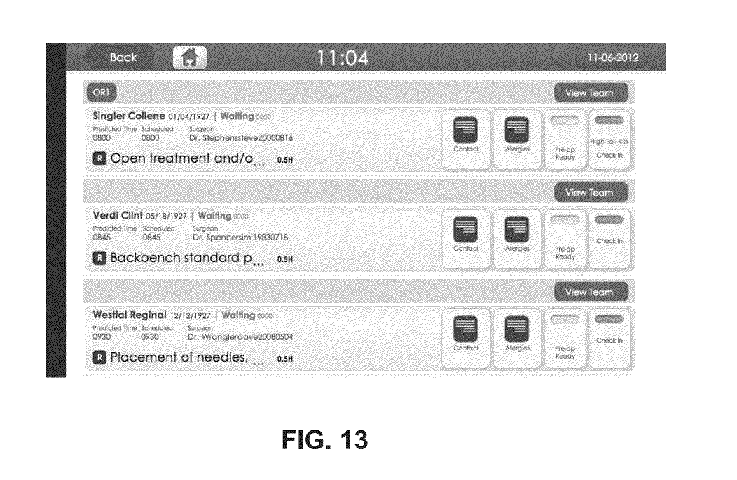

In the event a patient is determined to have high fall risk, the system will register such risk and display the risk on related screens (e.g., FIG. 13), as discussed throughout the disclosure. Such registration of high risk, in one embodiment, triggers downstream procedures and/or events.

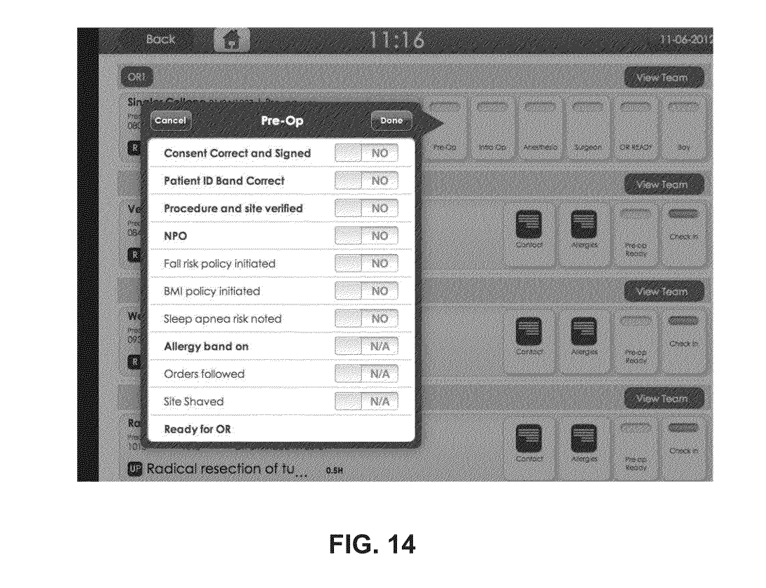

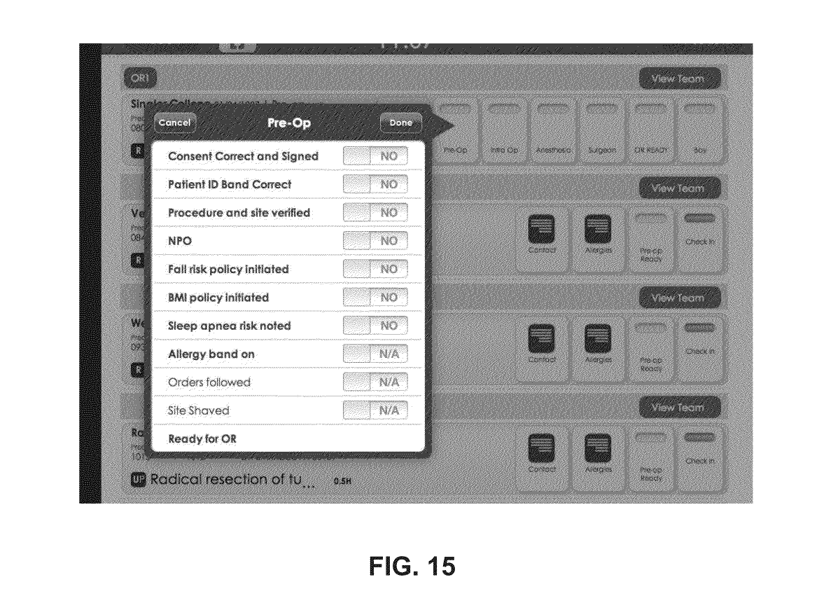

For instance, if a patient is not labeled as high fall risk, the patient would go through a pre-operation check list that does not mandate cautions of such items (FIG. 14). By contrast, for a patient that has perceived high fall risk, such mandatory items are required (FIG. 15, bold letters indicating mandatory checklist items).

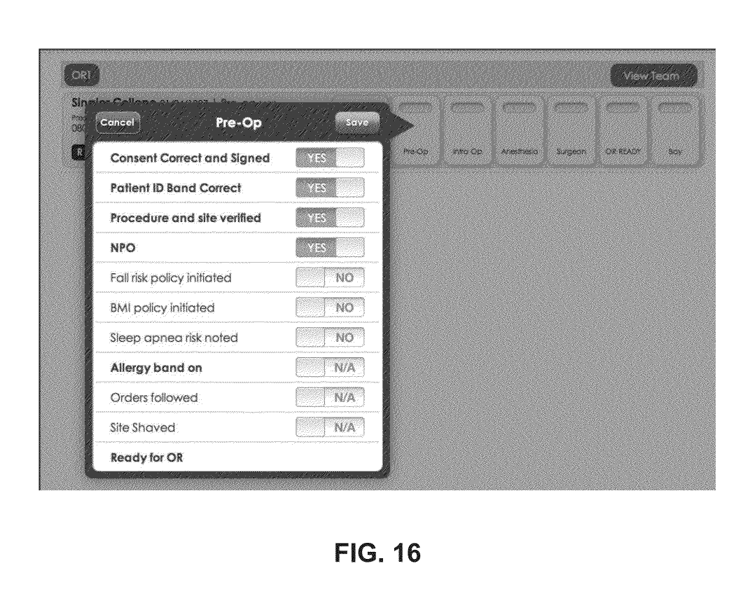

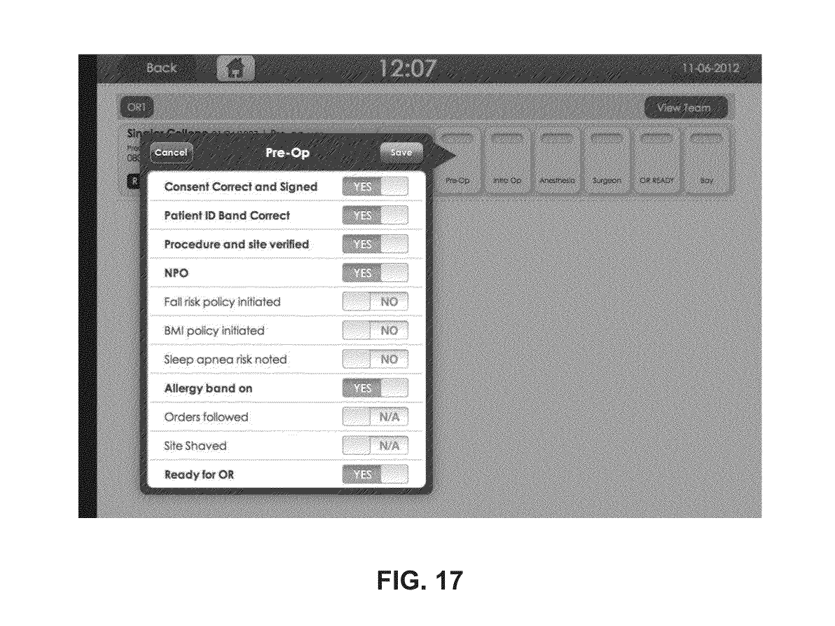

In this context, when a staff member reviews and updates the pre-operation checklist, the staff member would be required to check off every single mandatory item, such as those in bold letters in FIGS. 16 and 17 before readying a patient for operation. In FIG. 16, the mandatory item “Allergy band on” is not check checked off, and thus the patient cannot be moved to next step (i.e., the “Ready for OR” button is not available). By contrast, when the “Allergy band on” item is checked off (FIG. 17), the patient can then be readied for moving to the operation room.

Such a feature provides unique advantages. Present in a typical surgical facility, there is a pre-operative checklist that has to be followed. However, such a checklist right now is a paper checklist that doesn't take any patient specific factors into account. The present technology, however, makes the pre-op checklist interactive depending on the patient's medical conditions. If the patient has certain medical problems such as high fall risk, or sleep apnea risks or a high BMI, or allergies, theses items become bold in the pre-op checklist The user cannot move the patient to the OR until all bold items are checked. The bold items depend on the patient's medical conditions.

An item that the government is tracking is the number of patient falls in an ambulatory surgical center (ASC). In the present technology, if the patient is a high fall risk, this information is flagged on the application when the patient arrives—this way front office staff can get the patient in a wheelchair before they injure themselves.

### Alerts and Reminders

Prior to, during, and/or following a visit by a patient, the present disclosure also provides a system to generate automatic alerts and reminders. For instance, to patients, the system can generate reminders and alerts not to eat prior to a procedure, the surgery center address, what medications to take, what items to bring, what to wear etc. Following a procedure, the reminders and alerts can include when the patient can shower, remove bandages, take pain medications, what to look out for, i.e., signs of infection, when their appointment is.

For physicians, the reminders and alerts can include pre-op patient factors that could be of concern for an outpatient environment, e.g., morbid obesity, severe cardiac or pulmonary conditions and post operative problems.

Nurses can also receive reminders and alerts, such as patient workflow issues, patient factors of concern, instruments and equipment needed. Still, staff can receive equipment reminders, when a room needs to be cleaned, when an instrument is needed urgently. For administrator, the alert can relate to if an incident occurs in the ASC.

Accordingly, one embodiment of the present disclosure provides a computer system comprising a processor, memory and program code which, when executed, configures the system to:

take input from a healthcare facility personnel about a patient receiving healthcare service, wherein the input comprises biometric and/or medical conditions of the patient, and one or more expected surgical operation for the patient;

send an electronic pre-operative alert to the patient prior to the operation;

send an electronic post-operation alert to the patient following the operation;

send an electronic physician alert to a physician assigned to the patient for the operation prior to or during the operation; and

send an electronic nurse alert to a nurse assigned to the patient for the operation prior to, during or following the operation.

In one embodiment, the system is further configured to send an electronic staff alert to a healthcare facility staff member prior to, during or following the operation.

In one embodiment, the system is further configured to send an electronic administrator alert to a healthcare facility administrator prior to, during or following the operation.

In one embodiment, the pre-operative alert comprises information about the expected operation, information about the healthcare facility, and/or suggested diet, dressing and/or medication schedule.

In one embodiment, the post-operation alert comprises post-operation medication schedule, signs of complications, and/or contact information in case of medical attention.

In one embodiment, the physician alert comprises one or more risk factor associated with the patient. In one embodiment, the risk factor is selected from the group consisting of overweight, hypertension, abnormal blood glucose level, pain, allergy, nausea, infection, cardiac condition, pulmonary condition, and combinations thereof.

In one embodiment, the nurse alert comprises patient workflow, one or more risk factor associated with the patient, and/or equipment and/or services by the patient.

The reminders and alerts can be transmitted as an electronic signal, such as by text messages or electronic mails, without limitation.

### Service Monitoring and Comparison

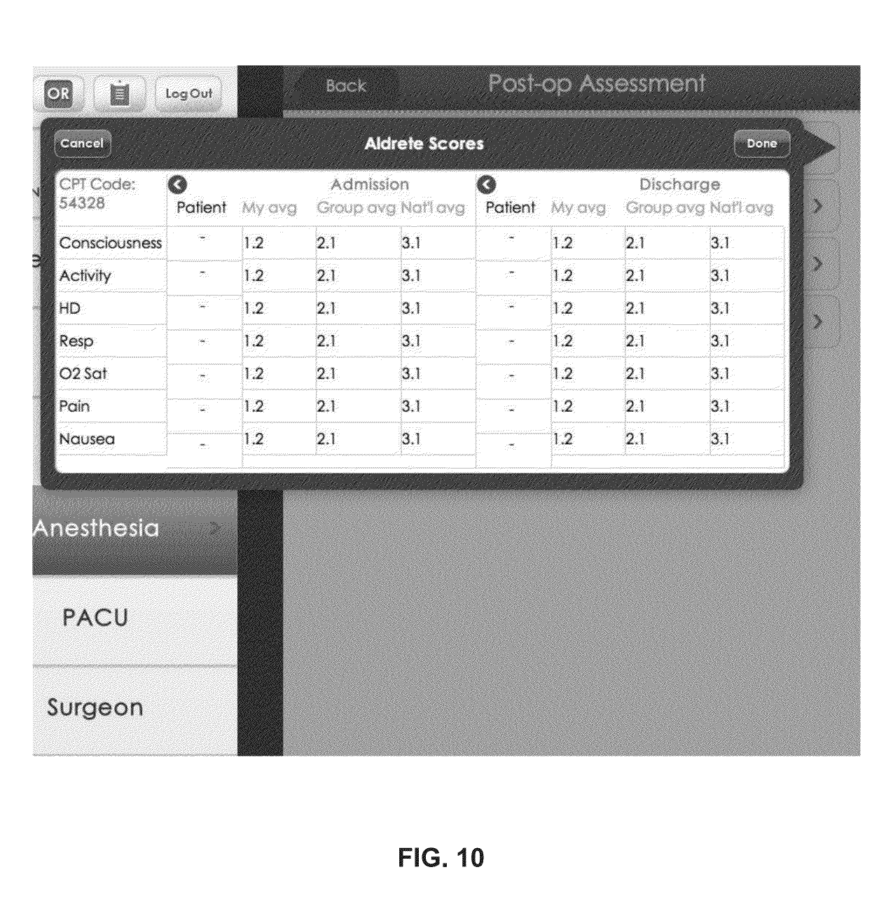

Average scores for specific clinical outcomes for each provider of care can be generated. These scores can be viewable by the provider and administrators at the center. These scores will be compared against their coworker peers and nationally with other users of the systems. FIG. 10 illustrates a table of such scores.

For example, for surgeons, their average post op infection rates, complication rates. For anesthesiologists, their average nausea and pain scores in PACU, their average time that a nerve block lasts.

Accordingly, one embodiment provides a computer system comprising a processor, memory and program code which, when executed, configures the system to:

take pre-operative information from a patient expected to take an surgical operation, which pre-operative information comprises scores from measuring two, three, four, five or more factors of: consciousness, activity, hemodynamics, response, oxygen saturation, pain, and/or nausea from the patient;

take post-operation information from the patient after the patient has completed the operation, which post-operation information comprises scores from measuring the factors from the patient; and

display an improvement score based on the pre-operative information and the post-operation information for the patient for each of the factors.

In one embodiment, the system is further configured to display summary improvement scores from other patients, as shown in FIG. 10.

The system of the present disclosure can also be used to generate clinical risk profile for each patient. Each patient's risk profile created from their medical history and the procedure they are having can be included in the profiles. Using the deidentified data that the system gathers, the system can have a better understanding of the risk profiles that each patient has as they present for treatment. This could be presented as just numbers or a clinical profile—this information will be accessible by providers taking of the patient.

Another benefit of using the system of the present disclosure is the ability to generate surgical counts. Nurses need to do a count of the equipment that is put into the surgical field. The “count” ensures that no equipment is left in the patient at the end of the procedure. Currently the surgical count is done on an erasable whiteboard in the OR. That is, the RN and scrub are relied upon to do the math correctly in a high pressure environment. In some aspects, the counts will be displayed on the screen in the OR. The system can do the math for the nurses and scrub in the OR.

### Scheduling Algorithms

Currently, the healthcare service scheduling is done on paper. It is recognized that, for the same service, the duration can vary greatly. Therefore, paper-based scheduling is not accurate and can waste both the patients' and the staff's time.

The present disclosure provides methods and systems for providing improved scheduling. For example, the methods consider who the surgeon is (some surgeons are slower than others), who the anesthesiologist and nurses are, and who the patient is. In this respect, it is noted that, for instance, morbidly obese and very elderly patients take longer to operate on.

For instance, for two patients with appendicitis, a very elderly man with multiple medical problems is going to be in the hospital for a longer time than a 20-year old athlete. Likewise, a clinic appointment with an anxious depressed patient is going to take longer than a 5 year old with an ear infection.

Therefore, one embodiment of the present disclosure provides a computer system comprising a processor, memory and program code which, when executed, configures the system to calculate the duration of a surgical operation for a patient performed by a surgeon assisted with an anesthesiologist, wherein the calculation takes as input (a) information about the patient affecting duration of the operation and (b) a historic database, wherein the database comprises durations of a plurality of surgical operations performed by the surgeons and/or assisted by the anesthesiologist for a plurality of patients and, for each patient of the plurality, information about the patient.

In one embodiment, the information about the patient affecting duration of the operation comprises one or more of age, mobility, weight, medical history, allergy, medication, and/or mental status.

With such a prediction algorithm, the system can then accurately predict the duration of a procedure and accordingly carry out more efficient scheduling of procedures.

For any of the systems, methods and facilities described in this disclosure, it is noted that information collected and/or displayed can be achieved in a computer-readable medium, preferably in a database. The achieved information, about patients, medical professionals and procedures can then be mined to generate information that is helpful for billing, improvement of healthcare quality, and monitoring.

### Computer Network

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A healthcare service or facility comprising a waiting area, a pre-operative area, an operating area, a recovery area and a central processing area, wherein:
the waiting area comprises a waiting area screen configured to display a plurality of patients at the facility or expected to arrive at the facility, and for each patient, in what area the patient is located and/or what procedure the patient is taking;
the pre-operative area comprises a pre-operative area screen configured to display, for each of the patients, one or more of: arrival status, assigned pre-operative bay, procedure to take, assigned surgeon, assigned anesthesiologist, assigned pre-operative nurse, assigned operating area nurse, and/or assigned operating area;
the operating area comprises an operating area screen configured to display, for a patient of the plurality that is currently in the operating area, one or more of: the procedure to take, allergies, equipments needed, administration of antibiotics, and/or special requests;
the recovery area comprises a recovery area screen configured to display a list of patients that are finishing operation, and an assigned recovery bay therefor; and
the central processing area comprises a central processing area screen configured to display equipments and/or services needed for any patient and/or in any area in the facility.

2. The service or facility of claim 1, further comprising a break area comprising a break area screen configured to display to facility staff on break the status and/or location of the patients.

3. The service or facility of claim 1, further comprising a hallway comprising a hallway screen configured to display a list of operating areas in the facility and status of patients assigned to each operating area.

4. The service or facility of claim 1, wherein the pre-operative area screen is further configured to display for each patient whether the patient has seen the assigned surgeon, the assigned anesthesiologist, the assigned pre-operative nurse and/or the operating area nurse, and/or whether the assigned operating area is ready.

5. The service or facility of claim 1, wherein the per-operating area screen is further configured to indicate that the patient is ready to receive operation at the assigned operation room when the patient has seen the assigned surgeon, the assigned anesthesiologist, the assigned pre-operative nurse and the operating area nurse, and the assigned operating area is ready.

6. The service or facility of claim 1, wherein at least one of the screens is further configured to display, for a patient of the plurality, one or more risk factor associated with the patient and a recommended action in response to the risk factor.

7. The service or facility of claim 6, wherein the screen is further configured to display whether the recommended action has been taken.

8. The service or facility of claim 6, wherein the risk factor is selected from the group consisting of overweight, hypertension, abnormal blood glucose level, pain, allergy, nausea, infection, cardiac condition, pulmonary condition, and combinations thereof.

9. The service or facility of claim 1, further comprising a pre-operative screen configured to receive input relating to one or more risk factor.

10. The service or facility of claim 9, wherein the input comprises history of falling.

11. The service or facility of claim 10, further configured to determine the likelihood of falling of the patient during the service or at the facility based on the input.

12. The service or facility of claim 1, further comprising a check-in screen configured to present a questionnaire to verify a patient and/or procedure.

13. The service or facility of claim 1, further configured to present an operating room scheduling interface that combines schedules for all operating rooms to a single column and indicates the time when each schedule completes.

14. A computer system comprising a processor, memory and program code which, when executed, configures the system to:
take input from a healthcare facility personnel about a patient receiving healthcare service, wherein the input comprises biometric and/or medical conditions of the patient, and one or more expected surgical operation for the patient;
send an electronic pre-operative alert to the patient prior to the operation;
send an electronic post-operation alert to the patient following the operation;
send an electronic physician alert to a physician assigned to the patient for the operation prior to or during the operation; and
send an electronic nurse alert to a nurse assigned to the patient for the operation prior to, during or following the operation.

15. The system of claim 14, wherein the system is further configured to send an electronic staff alert to a healthcare facility staff member prior to, during or following the operation.

16. The system of claim 14, wherein the system is further configured to send an electronic administrator alert to a healthcare facility administrator prior to, during or following the operation.

17. The system of claim 14, wherein the pre-operative alert comprises information about the expected operation, information about the healthcare facility, and/or suggested diet, dressing and/or medication schedule.

18. The system of claim 14, wherein the post-operation alert comprises post-operation medication schedule, signs of complications, and/or contact information in case of medical attention.

19. The system of claim 14, wherein the physician alert comprises one or more risk factor associated with the patient.

20. The system of claim 19, wherein the risk factor is selected from the group consisting of overweight, hypertension, abnormal blood glucose level, pain, allergy, nausea, infection, cardiac condition, pulmonary condition, and combinations thereof.

21. The system of claim 13, wherein the nurse alert comprises patient workflow, one or more risk factor associated with the patient, and/or equipment and/or services by the patient.

22. The system of claim 13, wherein the alerts comprise text messages or electronic mails.

23. A computer system comprising a processor, memory and program code which, when executed, configures the system to:
take pre-operative information from a patient expected to take an surgical operation, which pre-operative information comprises scores from measuring three or more factors of: consciousness, activity, hemodynamics, response, oxygen saturation, pain, and/or nausea from the patient;
take post-operation information from the patient after the patient has completed the operation, which post-operation information comprises scores from measuring the three or more factors from the patient; and
display an improvement score based on the pre-operative information and the post-operation information for the patient for each of the factors.

24. The computer system of claim 22, wherein the system is further configured to display summary improvement scores from other patients.

25. A computer system comprising a processor, memory and program code which, when executed, configures the system to calculate the duration of a surgical operation for a patient performed by a surgeon assisted with an anesthesiologist, wherein the calculation takes as input (a) information about the patient affecting duration of the operation and (b) a historic database, wherein the database comprises durations of a plurality of surgical operations performed by the surgeons and/or assisted by the anesthesiologist for a plurality of patients and, for each patient of the plurality, information about the patient.

26. The computer system of claim 25, wherein the information about the patient affecting duration of the operation comprises one or more of age, mobility, weight, medical history, allergy, medication, and/or mental status.
